(19) United States
(12) Patent Application Publication
(10) Pub. No.: US 2017/0241384 A1
(43) Pub. Date: Aug. 24, 2017

(54) PUMP AND FUEL INJECTION DEVICE

(71) Applicant: MIKUNI CORPORATION, TOKYO (JP)

(72) Inventors: Hiroshi MIZUI, Kanagawa (JP); Hirokazu MURAKAMI, Kanagawa (JP)

(73) Assignee: MIKUNI CORPORATION, TOKYO (JP)

(21) Appl. No.: 15/518,768

(22) PCT Filed: Oct. 15, 2015
(86) PCT No.: PCT/JP2015/079230

§ 371 Date: Apr. 13, 2017

(30) Foreign Application Priority Data
Oct. 16, 2014 (JP) 2014-212038

(51) Int. Cl. F02M 37/06; F04B 17/05; F04B 9/04

(52) U.S. Cl. CPC F02M 37/06; F04B 9/04; F04B 17/05

(57) ABSTRACT

Provided are a pump and a fuel injection device, in which fuel discharge failure and fuel pressure failure are prevented by suppressing generation of vapor, thereby enabling vehicles, agricultural machines, generators, and the like, which are provided with internal combustion engines, to operate stably. A pump is provided with: a pump body having a pump chamber defined therein; a plunger reciprocating in response to the rotation of an eccentric cam, thereby feeding fuel sucked in the pump chamber to an injector; and an input portion to which rotational torque from the outside is applied. The input portion is provided with the eccentric earn coupled to a joint member connected to a rotating member; a boss section for rotatably supporting the joint member; and a bush for restricting the axial movement of the joint member.

### BACKGROUND OF THE INVENTION

Field of the Invention

The invention relates to a pump and a fuel injection device, and more particularly, to a pump and a fuel injection device for enabling internal combustion engines used in vehicles, agricultural devices, power generators and the like, to stably operate.

Description of Related Art

With regard to an internal combustion engine such as a motorcycle engine, the internal combustion engine is commonly used to pump a fuel from a tank to an injector by a pump, inject the fuel by the injector, and then pressurize a gas mixed by the fuel and air in a cylinder through a piston to cause an explosion so as to generate power.

In Patent Document 1, a pump includes a plunger pump section and a diaphragm pump section and is operated by utilizing a rotational torque from each of separated disposed motors.

In detail, the rotational torque of an output shaft of the motor is transmitted to a cam rotatably installed on a cylinder head so a plunger provided in the plunger pump section reciprocate by pressing against the rotating cam. Through the reciprocating plunger, the fuel is guided from a tank through a suction valve into a pressurizing chamber to be pressurized, and then the pressurized fuel is discharged from a discharge valve.

Moreover, the diaphragm pump section is used to assist the plunger pump section for sucking in the fuel through the suction valve.

### PRIOR ART DOCUMENT

### Patent Document

Patent Document 1: Japanese Patent Publication No. 2013-148002

### SUMMARY OF THE INVENTION

The conventional pump as recited in Patent Document 1 is high in costs due to the motors required for operating the pump. Other than that, a fuel injection device using such pump is also high in costs due to batteries required for operating the motors.

Also, various models operated without power generating devices or batteries also exist among engines equipped with a manual starting device (a recoil starter). When a fuel injection (FL, an electronically controlled fuel injection) system for achieving low fuel efficiency, low exhaust and higher starting rate is applied to those models operated without power generating devices or batteries, the costs will be considerably high since a new power generating device for operating the FI system must be installed. In particular, power required for driving a high pressure pump accounts for a large proportion of the total power required by the FI system.

Accordingly, if the pump is driven by a rotating power of a member rotating in response to the engine, the pump must be disposed close to a combustion chamber of the engine, such that the environmental temperature of the pump will rise to approach a temperature of the engine.

If the environmental temperature is higher than such temperature, vapor can easily be generated on a fuel supply path or a low pressure section of the pump. In this case, if vapor is sucked in by the pump, fuel discharge failure and fuel pressure failure will occur to make maintaining a stable operation even harder. Also, when restarting the engine, it is difficult for the engine to start if vapor is sucked in by the pump.

Further, it is easier for vapor to generate in lower pressure and higher temperature. In order to suppress generation of vapor, ideally, the pump provided with the low pressure section is disposed at places with low environmental temperature. At this point, if the engine belongs to a type that disposes an exhaust pipe on top of an engine head, the environmental temperature for using the pump will become higher due to the heat from the exhaust pipe. Yet, if the exhaust pipe is disposed away from the top of the engine head, a total height of the engine will increase.

Further, with regard to engines used in general power generator, an engine body may have to be accommodated within a sound-insulating chamber for lower noise. In such case, since the environmental temperature for using the pump will definitely increase, it is especially difficult to keep the stability or the restart ability in such high temperature environment. What is more, if the total height of the engine does increase as mentioned above, the sound-insulating chamber may not be able to accommodate the engine at all.

The invention provides a pump and a fuel injection device, which are capable of preventing fuel discharge failure and fuel pressure failure by suppressing generation of vapor thereby enabling vehicles, agricultural devices, power generators and the like, which are provided with internal combustion engines, to operate stably. Additionally, the pump and the fuel injection device can stably inject the fuel without relying on the motors while staying low in costs.

The pump feeds a fuel from a tank to an injector. The injector injects the fuel into an inlet pipe or a combustion chamber of an engine. The pump includes: a pump body, which has a pump chamber defined therein; an input section, applied with a rotational torque of a rotating member rotating in response to operation of the engine; and a reciprocating member, pressurizing and feeding the fuel sucked in the pump chamber to the injector. The input section includes: a cam, coupled to a transmitting member connected to the rotating member and transmitting the rotational torque for enabling the reciprocating member to reciprocate; a bearing section, rotatably supporting the transmitting member; and a presser section, restricting movements of the transmitting member in an axial direction.

According to the above configuration, the transmitting member is used to connect the rotating member and the cam, and the cam is used to enable the reciprocating member to reciprocate. In this way, the transmitting member can be used to operate the pump without relying on the motors, and thus the motors for operating the pump are not required so the costs are lowered. Moreover, the transmitting member can be used to separately dispose high temperature sections (e.g., the pump and the cylinder of the engine) so the low pressure sections prone to generation of vapor can be prevented from becoming high in temperature to thereby suppress generation of vapor.

Further, the bearing section supports on one end of the transmitting member in the axial direction, and a length of the bearing section in the axial direction of the transmitting member is twice or more than twice an inner diameter of the bearing section.

According to the above configuration, a lateral vibration of the transmitting member can be suppressed by increasing a contact area of the bearing section and the transmitting member, so the fuel can be fed to the injector with stable timing.

Further, the bearing section rotatably supports the transmitting member through a bush.

According to the above configuration, the bush can be used to ensure that the transmitting member rotates smoothly while suppressing the lateral vibration of the transmitting member, so the fuel can be fed to the injector with stable timing.

Furthermore, a seal is installed between the bearing section and the transmitting member.

According to the above configuration, the seal can be used to prevent dust intrusion between the bearing section and the transmitting member to ensure that the transmitting member can rotate smoothly, so the fuel can be fed to the injector with stable timing.

Further, the transmitting member includes: a rotary cable, having a rotating inner cable and a non-rotating outer cable; a joint member, coupling the inner cable with the cam for supporting an outer periphery on the bearing section; and a connection member, connecting the outer cable with an outer periphery of the bearing section, the pump including a cover covering the outer cable and the connection member.

According to the above configuration, the cover can be used prevent dust intrusion between the connection member and the transmitting member and between the outer cable and the inner cable to ensure that the transmitting member rotates smoothly, so the fuel is fed to the injector with stable timing.

The rotating member is a crank shaft, a balancer shaft, a cam shaft or a governor, the input section is connected to the transmitting member, and the transmitting member transmits the rotational torque to the cam from the crank shaft, the balancer shaft, the cam shaft or the governor.

According to the above configuration, the existing rotating member disposed on the engine can be used to drive the pump thereby suppressing the number of parts from increasing, so as to realize low costs and resource saving.

Further, the input section is connected to the transmitting member, and the transmitting member transmits the rotational torque to the cam from the crank shaft installed with a recoil starter, or the balancer shaft, the cam shaft or the governor operated together with the crank shaft.

According to the above configuration, when the engine is operated by using the recoil starter, the transmitting member connected to the crank shaft, the balancer shaft, the cam shaft or the governor is used to mechanically operate the pump, so power generated by an engine control unit (ECU) can be increased during recoiling. In this way, as compared to the pump driven by the motors, speed for pressurizing the fuel can be accelerated during recoiling to thereby reduce a recoiling count before starting.

Also, the input section can also be connected to the transmitting member containing a bevel gear or a worm gear.

According to the above configuration, with regard to the torque transmission of the rotary cable and the rotating member, an orientation of the rotational torque is changed by using the bevel gear or the worm gear. As such, the rotary cable can be disposed according to a shape of the engine so the pump can be disposed at any position to thereby improve the degree of freedom in design.

In addition, a fuel injection device according to the invention includes: said pump, said injector connected to said pump, and the transmitting member connected to the rotating member and the input section.

According to the above configuration, the transmitting member is used to connect the rotating member and the cam, and the cam is used to enable the reciprocating member to reciprocate. In this way, the transmitting member can be used to operate the pump without relying on the motors, and thus the motors for operating the pump and the batteries for operating the motors are not required so the costs are lowered. Moreover, the transmitting member can be used to separately dispose high temperature section (e.g., the pump and the cylinder of the engine) so the low pressure sections prone to generation of vapor can be prevented from becoming high in temperature to thereby suppress generation of vapor.

The pump according to the invention is low in costs since use of the motors for operating the pump is not required and is able to suppress generation of vapor.

Further, according to the invention, the fuel can be fed to the injector with stable timing.

Further, according to the invention, the number of parts can be suppressed from increasing, so as to realize low costs and resource saving.

Further, the degree of freedom in disposition of the pump can be improved.

Further, speed for pressurizing the fuel can be accelerated during recoiling to reduce a recoiling count before starting.

Further, the rotary cable can be disposed according a shape of the engine so the pump can be disposed at any position to thereby improve the degree of freedom in design.

Further, fuel discharge failure and fuel pressure failure of the pump in the high temperature environment can be prevented to provide favorable operability and higher restart ability in the high temperature environment.

Further, the fuel injection device according to the invention is low in costs since use of the motors for operating the pump and the batteries for operating the motors is not required, and is able to suppress generation of vapor.

### BRIEF DESCRIPTION OF THE DRAWINGS

FIG. 1 is block diagram illustrating a configuration of a fuel injection device.

FIG. 2 shows a 3D view of a pump.

FIG. 3 shows a cross-sectional view of the pump depicted in FIG. 2 along line III-III.

FIG. 4 shows a cross-sectional view of a joint section of a rotary cable and a balancer shaft.

FIG. 5A shows a top view of a joint section of the rotary cable and the balancer shaft according to another example, and FIG. 5B is a cross-sectional view thereof.

FIG. 6A is a side view of one end of the inner cable, FIG. 6B is a cross-sectional view of FIG. 6A along line VIB-VIB, and is a diagram showing a cross-section of the cable body, and FIG. 6C is a cross-sectional view of FIG. 6A along line VIC-VIC, and is a diagram showing a cross-section of the connection end.

FIG. 7A is a side view of one end of the inner cable, FIG. 7B is a diagram showing one end of the inner cable in the axial direction, and FIG. 7C is a diagram showing one end of the inner cable in the axial direction in another example.

FIG. 8A is a side view of one end of the inner cable, FIG. 8B is a diagram showing one end of the inner cable in the axial direction, and FIG. 8C is a diagram showing one end of the inner cable in the axial direction in another example.

FIG. 9 is a schematic diagram illustrating a configuration for retrieving a rotational torque from a governor through a gear rotating around a transmission shaft and a rotation supporting shaft in parallel thereto.

FIG. 10 is schematic diagram illustrating a configuration for retrieving a rotational torque from a governor through a bevel gear.

FIG. 11A is schematic diagram illustrating a configuration for retrieving a rotational torque from a governor through a worm, and FIG. 11B is a side view of FIG. 11A.

FIG. 12 is a schematic diagram illustrating another configuration for retrieving the rotational torque from the governor from a worm.

FIG. 13 is a partial enlarged cross-sectional view illustrating a configuration of a pump using a bearing to support a joint member.

FIG. 14 is a partial enlarged cross-sectional view illustrating a configuration of a pump using a cylindrical bush to support a joint member.

FIG. 15 is a partial enlarged cross-sectional view illustrating a configuration of a pump using a flange bush to support a joint member.

FIG. 16 is a partial enlarged cross-sectional view illustrating a configuration of a pump provided with a seal installed between a joint member and a boss section.

FIG. 17 is a partial enlarged cross-sectional view illustrating a configuration of the pump provided with a dust-proof cover installed on a flare nut and an outer cable.

### DESCRIPTION OF THE EMBODIMENTS

The pump and the fuel injection device according to the embodiments of the invention will be described below with reference to the drawings.

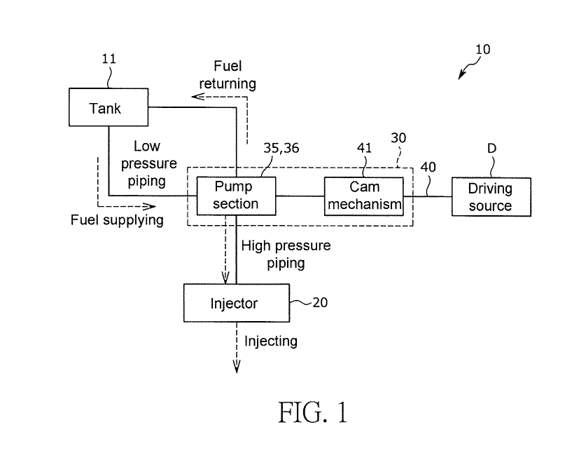

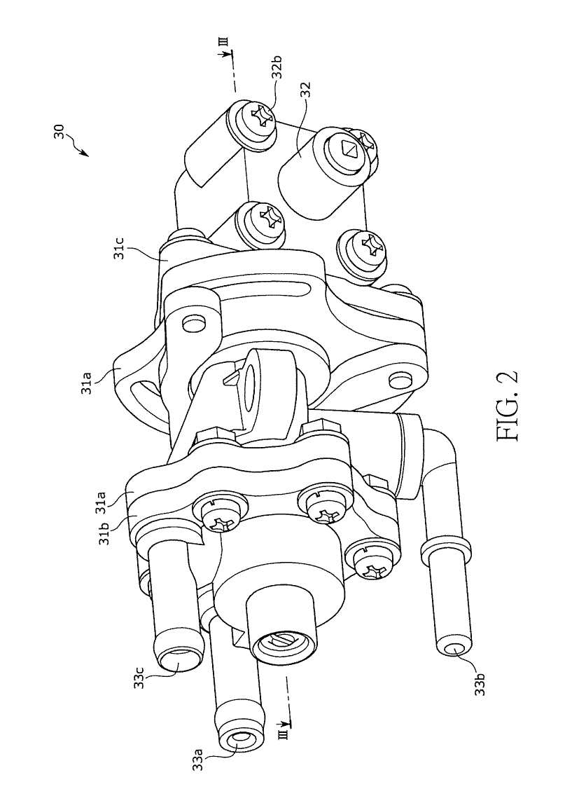

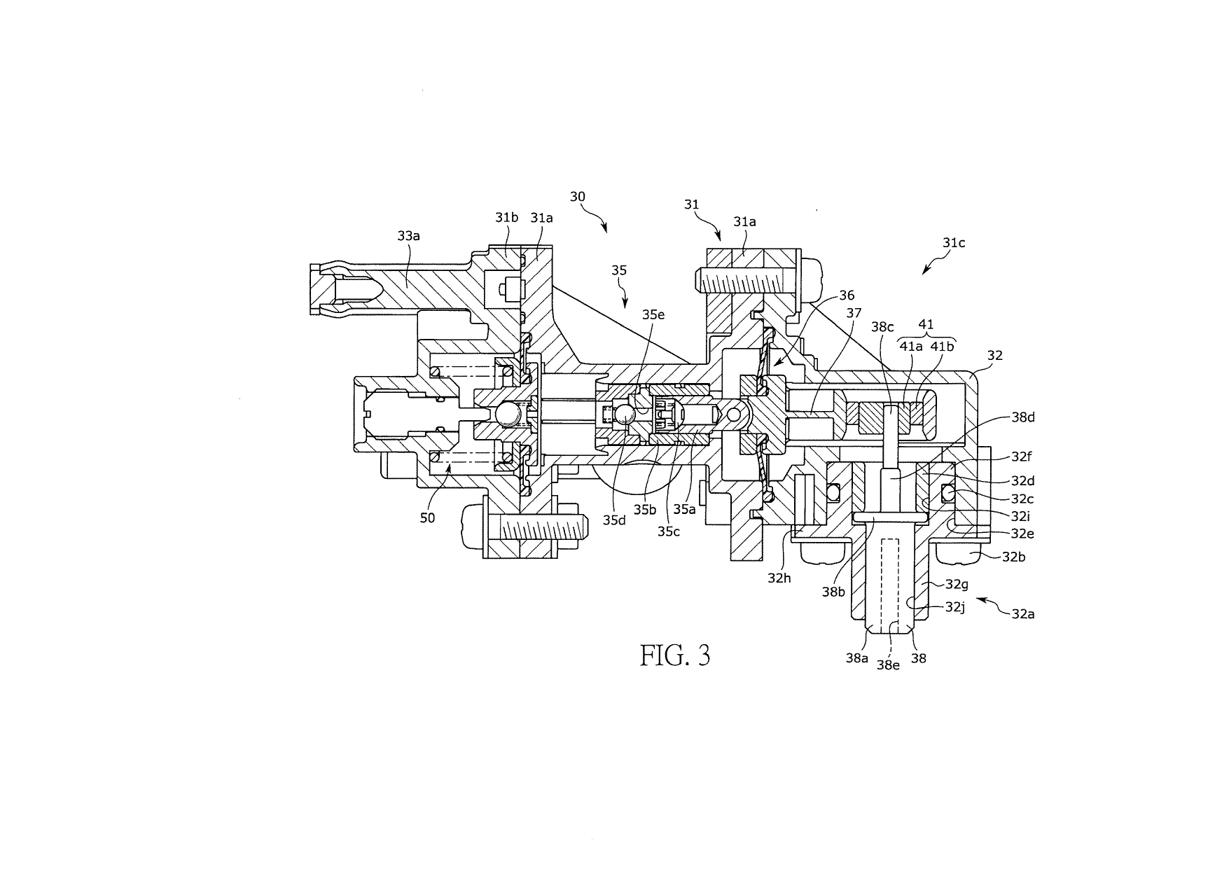

A fuel injection device 10 is a device for injecting a fuel to the air already introduced in an inlet pipe or a combustion chamber of an internal combustion engine. As shown in FIG. 1, the fuel injection device 10 includes a tank 11 for accumulating the fuel, an injector 20 for injecting a fuel into an inlet pipe or a combustion chamber of an engine (not illustrated), a pump 30 as depicted in FIG. 2 and FIG. 3, a driving source D for driving the pump 30, and a rotary cable 40 (equivalent to a part of the transmitting member in the present invention) for connecting the driving source D with the pump 30.

FIG. 1 is block diagram illustrating a configuration of a fuel injection device 10, FIG. 2 shows a 3D view of the pump 30, and FIG. 3 shows a cross-sectional view of the pump 30 depicted in FIG. 2 along line III-III.

First, with reference to FIG. 1, overall configuration of the fuel injection device 10 is described as follows. The fuel injection device 10 of the present embodiment is characterized in that, the driving source D of the driving pump 30 refers to a crank shaft 61, a balancer shaft 60, a governor 65 (which are be described later) or a cam shaft (not illustrated; equivalent to a rotating member in the present invention, also known as the crank shaft 61 hereinafter) rotating in response to the engine (not illustrated); power is transmitted to the pump 30 from the crank shaft 61 and the like through the rotary cable 40 with flexibility and a cam mechanism 41.

A plunger 35a (to be described later) operates after power is transmitted to the pump 30 to provide the fuel supplied by the tank 11 through an injector connector 33b to the injector 20 where the fuel is discharged to the inlet pipe or the combustion chamber of the engine.

Next, the pump 30 is described below with reference to FIG. 2 and FIG. 3. Furthermore, aside from an input portion 31c (to be described later) applied with the rotational torque, the pump in the following descriptions has the same configuration as disclosed in Patent Document 1, and thus the description regarding the same are not provided in detail but briefly explained.

The pump 30 mainly includes the following three portions: a body portion 31a for sucking the fuel and pressurizing the sucked fuel, a cover portion 31b for blocking the body portion 31a, and the input portion 31c (equivalent to the input section in the present invention) applied with the rotational torque for pressurizing the fuel.

In terms of functionality, the pump 30 includes: a plunger pump section 35 for pressurizing the fuel, a diaphragm pump section 36 for assisting in pressurizing the fuel, and a pressure regulator 50 for regulating the pressure on the pressurized fuel.

First, the input portion 31c of the pump 30 is described as follows. The input portion 31c is a portion applied with the rotational torque from the crank shaft 61 (to be described later) and the like through the rotary cable 40.

The input portion 31c mainly includes the cam mechanism 41, an input section body 32 constituting a part of a pump body 31 and covering the cam mechanism 41, and a boss-attached presser 32a secured on the input section body 32 for securing the joint member 38.

The cam mechanism 41 converts the rotational torque applied from the joint member 38 into a load for a fixture piece 37 and the plunger 35a to reciprocate, and includes an eccentric cam 41a and a cam bearing member 41b covered thereon.

The joint member 38 is equivalent to a part of the transmitting member in the present invention, which mainly includes: an input shaft 38a having a bearing hole 38e, connected to the rotary cable 40, a flange 38b supporting a tubular bush 32d and a flange 38b in thrust direction and having a diameter formed to be greater than the other members, and a fitting shaft 38c inserted and fitted into the eccentric cam 41a. The joint member 38 can be rotatably supported by the input section body 32 using the boss-attached presser 32a.

The boss-attached presser 32a includes: a large diameter tube section 32f, fitted into a groove with circular cross-section (i.e., a fitting groove 32e) of the input section body 32; and a tubular boss section 32g, having an outer diameter formed to be smaller than an outer diameter of the large diameter tube section 32f and protruding to the outside of the pump 30.

In detail, the large diameter tube section 32f is fitted into the groove (i.e., the fitting groove 32e) with circular cross-section of the input section body 32 by using an O-ring 32c installed on its peripheral surface. Further, an inner surface of a hollow section 32i of the large diameter tube section 32f passing through a central shaft is formed substantially identical to an outer surface of the tubular bush 32d, formed with an inner diameter slightly greater than an outer diameter of the flange 38b, and formed to restrict movements of the joint member 38 in an axial direction.

A hollow section 32j passing through the central shaft is formed on the boss section 32g, an inner surface of the hollow section 32j formed on the boss section 32g is formed substantially identical to an outer surface of the input shaft 38a. That is, the inner surface of the hollow section 32j formed on the boss section 32g functions as a bearing section to the input shaft 38a. In addition, the input shaft 38a is formed protruding from the boss section 32g to the outside.

After being placed in close contact with an outer periphery of the fitting groove 32e of the input section body 32, a flange section 32h is secured on the input section body 32 by using a tapping screw 32b. The joint member 38 is rotatably supported by using the bush 32d, and installed on the input section body 32 together with the boss-attached presser 32a secured in the fitting groove 32e.

The joint member 38 with such configuration can restrict movements in thrust direction by the bush 32d (equivalent to the presser section in the invention), so as to suppress vibration in the axial direction. Moreover, the joint member 38 is rotatably supported by the inner surface of the hollow section 32j formed on the boss section 32g to thereby suppress a lateral vibration of the joint member 38. Herein, in order to further suppress the lateral vibration of the joint member 38 by increasing a contact area with a lateral surface of the input shaft 38a of the joint member 38, ideally, a length of the hollow section 32j in the axial direction is set to be twice or more than twice a diameter thereof.

The body portion 31a is provided with a plunger pump section 35, and provided with a diaphragm pump section 36 beside the input portion 31c and provided with the pressure regulator 50 beside the cover portion 31b.

In the plunger pump section 35, the fixture piece 37 reciprocates in response to rotation of the eccentric cam 41a, and the plunger 35a secured on the fixture piece 37 reciprocates inside a sleeve 35b. The plunger 35a is equivalent to the reciprocating member of the invention. In response to reciprocating movement of the plunger 35a, a suction valve 35c sucks in the fuel from the tank 11 through an intake connector 33a into a pump chamber 35e so a discharge valve 35d can discharge the fuel in the pump chamber 35e to the injector 20.

Further, the diaphragm pump section 36 is used to improve insufficient sucking capability of the pump chamber 35e of the plunger pump section 35. Also, the pressure regulator 50 can maintain the fuel supplied to the injector 20 at a predetermined pressure.

The cover portion 31b includes: the intake connector 33a, covering the body portion 31a and introducing the fuel from the tank 11 to the pump 30; and a return connector 33c shown in FIG. 1, returning a part of the fuel (the remaining fuel exceeding the predetermined pressure) supplied to the injector 20 back to the tank 11.

According to the rotational torque applied from the rotary cable 40, the pump 30 with such configuration is used to suck in the fuel from the tank 11, and pressurizing the sucked fuel to the predetermined pressure to be supplied to the injector 20.

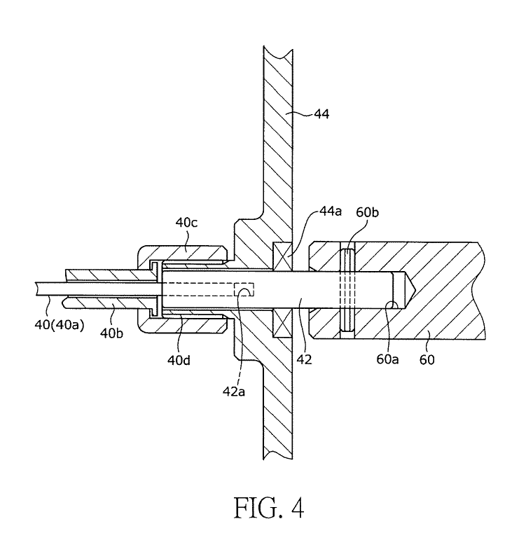

Next, various configurations for transmitting the rotational torque of the balancer shaft 60 and the like to the pump 30 are described below with reference to FIG. 4, FIG. 5A and FIG. 5B.

Herein, FIG. 4 shows a cross-sectional view of a joint section of the rotary cable 40 and the balancer shaft 60, FIG. 5A shows a top view of a joint section of the rotary cable 40 and the balancer shaft 60 according to another example, and FIG. 5B is a cross-sectional view thereof.

The rotary cable 40 shown in FIG. 4 has one end connected to the balancer shaft 60 through the joint member 42, and has another end installed on the input section body 32 of the pump 30 through the joint member 38 shown in FIG. 3 to be pressed against the cam mechanism 41.

In more detail, on one end of the balancer shaft 60, a bearing hole 60a is formed on an extended line substantially coaxial to a rotation axis of the balancer shaft 60.

The joint member 42 (equivalent to a part of the transmitting member in the present invention, which is in a rod shape having substantially the equal cross-section of the bearing hole 60a) has one end inserted into the bearing hole 60a and secured by a fixing pin 60b in a synchronized rotating manner. The joint member 42 passing through a crank case 44 and is rotatably supported by the seal 44a of the crank case 44. On another end of the joint member 42 exposed outside the crank case 44, a bearing hole 42a with a square cross-section is formed on a center line extended in the axial direction and on the extended line substantially coaxial to the rotation axis of the balancer shaft 60.

A thread section 40d is formed around a protruding portion of the crank case 44 for the joint member 42 to pass through.

When an inner cable 40a is inserted to the bearing hole 42a of the joint member 42, a flare nut 40c engaged with an outer cable 40b with flange is screwed into the thread section 40d so the rotary cable 40 is connected to the joint member 42 or even to the balancer shaft 60.

As such, by linearly retrieving the rotational torque of the balancer shaft 60 by using the rotary cable 40 disposed on the extended line of the balancer shaft 60, the vibration of the rotary cable 40 is suppressed accordingly so the rotational torque can be retrieved from the balancer shaft 60 efficiently.

The rotary cable 40 shown in FIG. 5A and FIG. 5B has one end arranged in direction orthogonal to the axial direction of the balancer shaft 60 to be connected to the balancer shaft 60 through a joint member (45, 46) having a bevel gear (45a, 46a).

In more detail, the joint member 45 (equivalent to a part of the transmitting member in the present invention) has one end in a rod shape having substantially the equal cross-section of the bearing hole 60a, and has another end having the bevel gear 45a. Said one end the joint member 45 is inserted to the bearing hole 60a, and secured by the fixing pin 60b in a synchronized rotating manner. Further, the joint member 45 is rotatably supported by the seal 44a of a joint cover 47 in a substantially L shape. In addition, the joint cover 47 is fitted and installed to the crank case 44 by using an O-ring 47b.

The joint member 46 (equivalent to a part of the transmitting member in the present invention) has one end having the bevel gear 46a and another end in a rod shape. The joint member 46 is disposed in a direction orthogonal to the joint member 45 and rotatably supported on the joint cover 47, and the bevel gear 46a is disposed by engaging with the bevel gear 45a.

On another side of the joint member 46, the bearing hole 46b with a square cross-section is formed on a center line extended along the axial direction and on an axial direction substantially orthogonal to the rotation axis of the balancer shaft 60.

A thread section 47a is formed around a protruding portion of the joint cover 47 for the joint member 46 to pass through.

When the inner cable 40a is inserted to the bearing hole 46b of the joint member 46, the flare nut 40c engaged with the outer cable 40b with flange is screwed into the thread section 47a so the rotary cable 40 is connected to the joint member (45, 46) or even to the balancer shaft 60.

With the joint member (45, 46) having the bevel gears (45a, 46a) according to the above configuration, the rotary cable 40 can be pulled out from the direction orthogonal to the axial direction of the balancer shaft 60. Therefore, the degree of freedom in disposition of the pump 30 connected to the rotary cable 40 can be improved, and the pump 30 can be prevented from being disposed in the high temperature environment.

Although an example is described above using the rotary cable 40 in which one end of the inner cable 40a is the square cross-section, the shape is not particularly limited so long as the rotational torque can be transmitted.

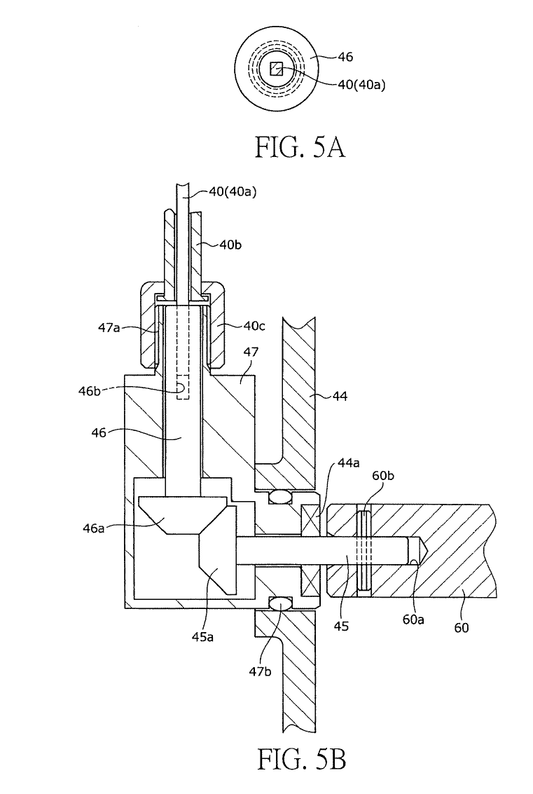

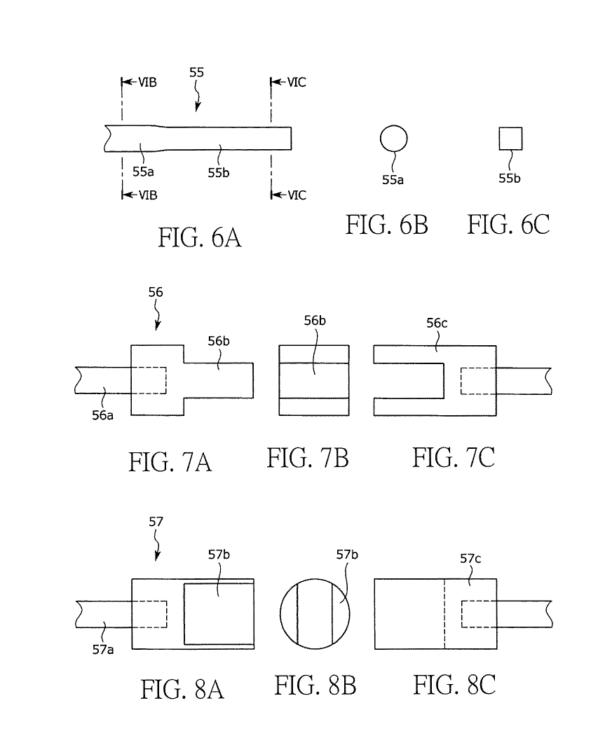

Hence, other possible shapes at ends of inner cables 55, 56 and 57 are described below with reference to FIG. 6 to FIG. 8. Herein, FIG. 6A is a side view of one end of the inner cable 55; FIG. 6B is a cross-sectional view of FIG. 6A along line VIB-VIB, and is a diagram showing a cross-section of a cable body 55a of the inner cable 40a; FIG. 6C is a cross-sectional view of FIG. 6A along line VIC-VIC, and is a diagram showing a cross-section of a connection end 55b; FIG. 7A is a side view of one end of the inner cable 56; FIG. 7B is a diagram showing one end of a connection end 56b of the inner cable 56 in the axial direction; FIG. 7C is a diagram showing one end of the inner cable 56 in the axial direction in another example; FIG. 8A is a side view of one end of the inner cable 57; FIG. 8B is a diagram showing one end of the inner cable 57 in the axial direction; and FIG. 8C is a diagram showing one end of the inner cable 57 in the axial direction in another example.

The inner cable 55 shown in FIG. 6A is formed by the cable body 55a with a circular cross-section as shown in FIG. 6B and the connection end 55b with a square cross-section as shown in FIG. 6C. As such, because of the square cross-section, the connection end 55b can be fitted in the bearing hole 46b with the square cross-section to transmit a rotating power to the joint member 46 through rotation.

The inner cable 56 shown in FIG. 7A and FIG. 7B is formed with the connection end 56b connected to a front end of the cable body 56a. The connection end 56b is formed with a convex cross-section protruding outwardly towards an axial direction and a predetermined thickness.

As such, because connection end 56b is formed with the convex cross-section, if the joint member (42, 46) formed with a shape matching the connection end 56b is connected to the connection end 56b, the rotational torque from the joint member (42, 46) can then be transmitted to the connection end 56b.

Specifically, the so-called shape of the joint member (42, 46) matching the connection end 56b refers to the bearing hole (42a, 46b) in shape of a slot. The slot is formed into a shape with a width equal to or slightly greater than a width of a protruding section with the convex cross-section.

In addition, the convex shape of the connection end 56b may also be a complementary shape to the slot of the joint member (42, 46). In such case, a connection end 56c is formed with a concave cross-section and a predetermined thickness, as shown in FIG. 7C.

The inner cable 57 shown in FIG. 8A and FIG. 8B is formed with a connection end 57b connected to a front end of the cable body 57a. The connection end 57b is formed with a substantially cylindrical shape and a front end having a two-way taking shape.

In this way, because the connection end 57b is formed with the substantially cylindrical shape and formed with the front end having the two-way taking shape, if the joint member (42, 46) formed with a shape matching the connection end 57b is connected to the connection end 57b, the rotational torque from the joint member (42, 46) can then be transmitted to the connection end 57b.

Specifically, the so-called shape of the joint member (42, 46) matching the connection end 57b refers to the bearing hole (42a, 46b) in shape of a slot. The slot is formed into a shape with a width equal to or slightly greater than a width of an interface opposite to the two-way taking shape the connection end 57b.

In addition, the two-way taking shape of the connection end 57b may also be a complementary shape to the slot of the joint member (42, 46). In such case, a connection end 57c is formed with a slot, as shown in FIG. 8C.

Further, in the above configuration, although an example is described using the rotary cable 40 connected to the balancer shaft 60 through the joint member 42 or the joint member (45, 46), any one of the crank shaft 61, the cam shaft (not illustrated) may be connected and used as the driving source D rather than being limited only to be connected to the balancer shaft 60 so long as such member can rotate in response to the engine. Furthermore, modification examples for gaining power from the governor 65 used as the driving source D are described as follows.

### MODIFICATION EXAMPLES FOR RETRIEVING THE ROTATIONAL TORQUE

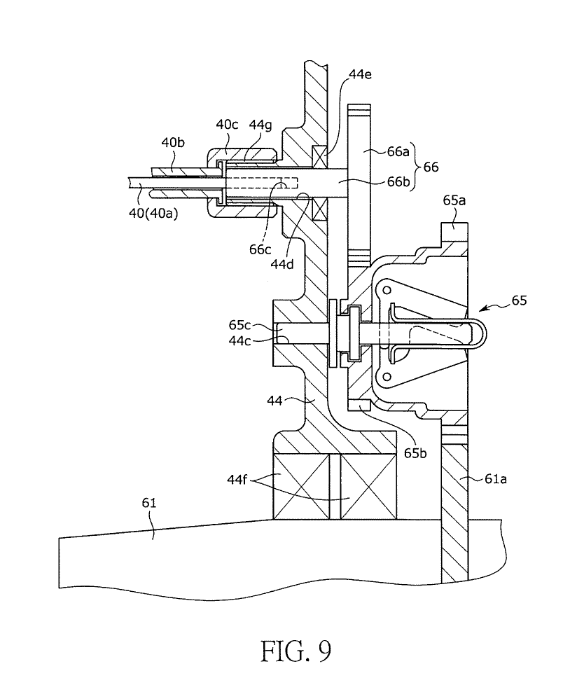

Next, configurations in various modification examples for transmitting the rotational torque from the governor 65 to the pump 30 are described below with reference to FIG. 9 to FIG. 12. Further, members already described or having the same functions in the embodiments are marked with the same reference numbers and description regarding the same is omitted hereinafter, so as bring out their differences more clearly.

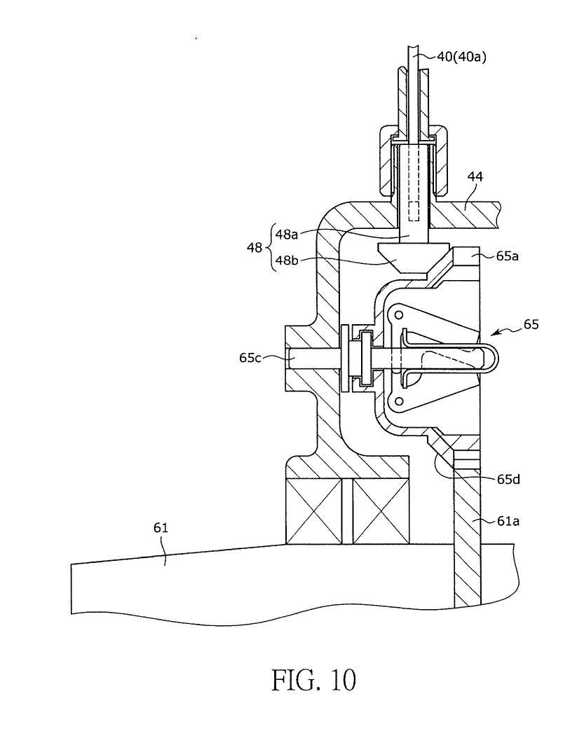

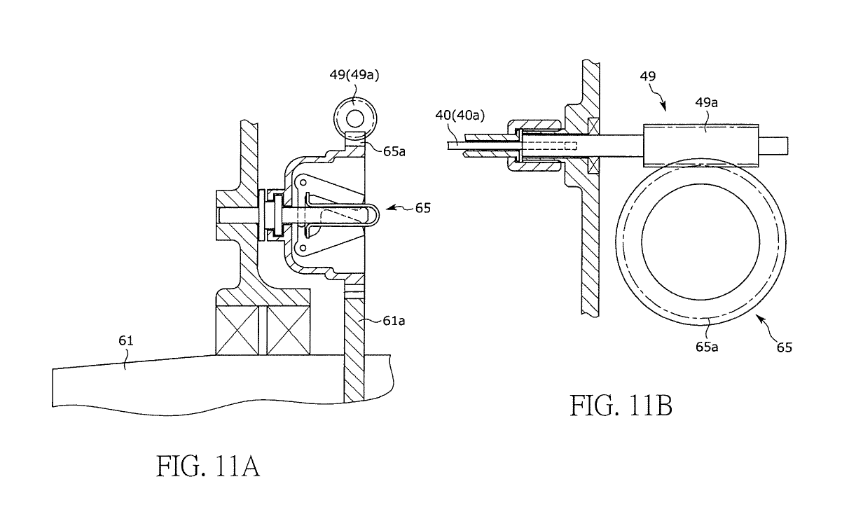

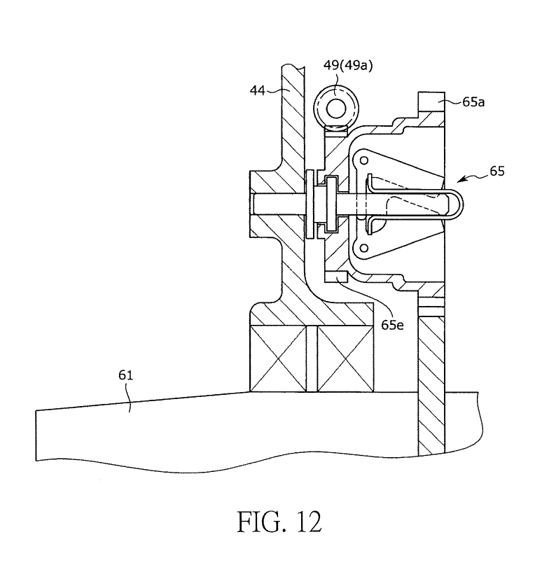

FIG. 9 is a schematic diagram illustrating a configuration for retrieving the rotational torque from the governor 65 through the gear rotating around a transmission shaft 66b and a rotation supporting shaft 65c in parallel thereto in the example where the governor 65 is used as the driving source D of the pump 30; FIG. 10 is schematic diagram illustrating a configuration for retrieving the rotational torque from the governor 65 through the bevel gear; FIG. 11A is schematic diagram illustrating a configuration for retrieving the rotational torque from the governor 65 through a worm 49a, and FIG. 11B is a side view of FIG. 11A. FIG. 12 is a schematic diagram illustrating another configuration for retrieving the rotational torque from the governor 65 from the worm 49a.

In the modification example shown in FIG. 9, the rotary cable 40 is pulled out from the crank case 44 in a direction parallel to a rotation axis of the governor 65 for adjusting a rotating speed of the crank shaft 61, and the pump 30 is rotationally driven through the governor 65, the joint member 66 rotating in response to the engagement with a governor gear 65b included by the governor 65, and the rotary cable 40.

The crank shaft 61 is rotatably supported on the crank case 44 by a seal 44f. Further, a gear 61a is integrally formed in the crank shaft 61 to rotate around a shaft thereof, and the gear 61a is engaged with a governor gear 65a formed on a peripheral surface of the governor 65.

The governor 65 is rotatably supported by the rotation supporting shaft 65c secured in the bearing hole 44c of the crank case 44 and rotates together with rotation of the crank shaft 61. In the governor 65, the governor gear 65b is formed beside the crank case 44 separating from the governor gear 65a. The governor gear 65b is formed on a peripheral surface of the joint member 66 and engaged with the joint gear 66a disposed adjacent thereto.

The joint member 66 (equivalent to a part of the transmitting member in the present invention) is a member connected to the governor 65 and the rotary cable 40, which includes the joint gear 66a and the transmission shaft 66b in a rod shape extended from a center of the joint gear 66a in a thickness direction of the joint gear 66a. The transmission shaft 66b extends in parallel to the crank shaft 61 and the rotation supporting shaft 65c, passes through a through hole 44d of the crank case 44, and is rotatably supported on the crank case 44 by a seal 44e. A bearing hole 66c with a square cross-section engaged with the inner cable 40a is formed in the transmission shaft 66b. The bearing hole 66c is formed starting from the end outside the crank case 44 along the axial direction. Further, a thread section 44g is formed around a protruding portion of the crank case 44 for the transmission shaft 66b to pass through.

When the inner cable 40a is inserted to the bearing hole 66c of the joint member 66, the flare nut 40c engaged with the outer cable 40b with flange is screwed into the thread section 47a so the rotary cable 40 is connected to the joint member 66 or even to the governor 65.

In particular, considering the engagement with the gear 61a formed on the crank shaft 61, the governor 65 is disposed on a wall side of crank case 44 in the axial direction starting from a center of the crank shaft 61.

Accordingly, the rotary cable 40 is used to retrieve the rotational torque from the governor 65 so a length of rotary cable 40 can be reduced when an output section is disposed on the wall side of the crank case 44.

Unlike the modification example shown in FIG. 9, in the modification example shown in FIG. 10, the rotary cable 40 is pulled out from the crank case 44 in a direction orthogonal to the rotation axis of the governor 65, and the pump 30 is rotationally driven through the governor 65, the joint member 48 rotating in response to the engagement with a bevel gear 65d included by the governor 65, and the rotary cable 40.

Unlike the modification example shown in FIG. 9, the bevel gear 65d is formed separating from the governor gear 65a on a portion adjacent to the governor gear 65a in the governor 65. Specifically, the bevel gear 65d is formed inclining to the rotation supporting shaft 65c with the diameter increasing away from a portion of the rotation supporting shaft 65c secured in the bearing hole 44c of the crank case 44 towards an inner side of the crank case 44.

The bevel gear 65d is engaged with a bevel gear 48b formed on a peripheral surface of the joint member 48.

The joint member 48 (equivalent to a part of the transmitting member) is a member connected to the governor 65 and the rotary cable 40, which includes the bevel gear 48b and a transmission shaft 48a in a rod shape extended from a center of the bevel gear 48b in a thickness direction of the bevel gear 48b. The transmission shaft 48a extends along a direction orthogonal to the crank shaft 61 and the rotation supporting shaft 65c.

According to the above configuration, by using the engagement of the bevel gear 48b of the governor 65 and the bevel gear 65d of the joint member 68, the rotary cable 40 can be pulled out from the crank case 44 in a direction orthogonal to the rotation supporting shaft 65c serving as the rotation axis of the governor 65.

In the modification example shown in FIG. 11A and FIG. 11B, unlike the other embodiments, the rotary cable 40 located at a torsional position with respect to the rotating shaft of the governor 65 is pulled out from the crank case 44. Specifically, the pump 30 is rotationally driven through the governor 65, the joint member 49 (equivalent to a part of the transmitting member in the present invention) having the worm 49a rotating in response to the engagement with the governor gear 65a included by the governor 65, and the rotary cable 40. Further, the worm gear of the invention is composed of the governor gear 65a and the worm 49a.

Unlike the modification examples shown in FIG. 9 and FIG. 10, the governor gear 65a of the governor 65 is engaged with the worm 49a of the joint member 49 and engaged with the gear 61a of the crank shaft 61. Further, the governor gear 65a is formed by a spur gear, and preferably, by a helical gear.

Furthermore, as shown in FIG. 12, in the governor 65, a helical gear 65e may also be formed beside the crank case 44 separating from the governor gear 65a engaged with the gear 61a of the crank shaft 61, so the helical gear 65e is engaged with the worm 49a. Accordingly, the gear 61a of the crank shaft 61 and the governor gear 65a engaged therewith can be set as the spur gear to prevent generation of thrust, and the gear to be engaged with the worm 49a can be set as the helical gear 65e to stabilize the engagement.

With such configuration, the worm gear shown in FIG. 11 and FIG. 12 can decrease the umber of rotations for the rotary cable 40 and reduce the vibration and a sliding sound of the rotary cable 40 to improve its durability. Further, in comparison with an accelerating generate (not illustrated) that is a gear disposed beside the pump 30, a maximum flow and a feeding flow of the pump 30 may further be set as any value.

Also, a direction for pulling out the rotary cable 40 from the crank case 44 can be orthogonal to the crank case 61 and the rotation supporting shaft 65c of the governor 65, or located on the torsional position.

Therefore, the rotary cable 40 can be pulled out from near the tank disposed on top of the crank case 44 or the tank 11 above the engine (not illustrated), so the rotary cable 40 can be shorten when the pump 30 is disposed inside the tank 11.

Further, a size of the crank case 44 can be reduced by using a worm gear not belonging to parallel shaft or cross shaft that is even more compact.

### MODIFICATION EXAMPLE OF BEARING STRUCTURE

In the configuration for operating the pump 30 by using the rotary cable 40 to retrieve the rotational torque from the crank shaft 61, the lateral vibration of the joint member 38 connected to the inner cable 40a may occur. Under such circumstance, it is concerned that the timing for feeding the fuel to the injector 20 may not be the ideal timing since it is difficult for the eccentric cam 41a fitted to the joint member 38 to rotate smoothly.

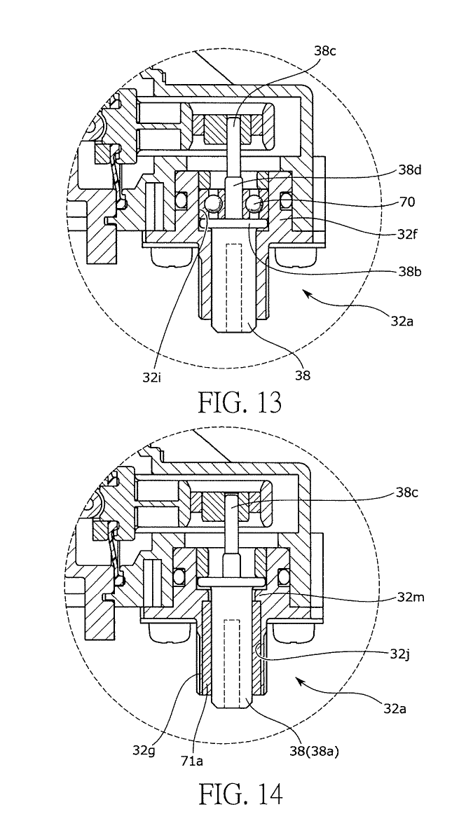

To prevent such adverse condition, the modification examples regarding the bearing structure for preventing the lateral vibration of the joint member 38 are described below with reference to FIG. 13 to FIG. 15.

Herein, FIG. 13 is a partial enlarged cross-sectional view illustrating a configuration of the pump 30 using a bearing 70 to support the joint member 38. FIG. 14 is a partial enlarged cross-sectional view illustrating a configuration of the pump 30 using a cylindrical bush 71a to support the joint member 38. FIG. 15 is a partial enlarged cross-sectional view illustrating a configuration of the pump 30 using a flange bush 71b to support the joint member 38.

In the configuration shown in FIG. 13, a supported shaft 38d with a diameter greater than the fitting shaft 38c is formed between the fitting shaft 38c and flange 38b in the joint member 38. The bearing 70 is fitted as a ball bearing between inner surfaces the supported shaft 38d and the boss-attached presser 32a facing the hollow section 32i.

According to such configuration, the supported shaft 38d can be rotatably supported by the bearing 70 so the lateral vibration can be prevented since the supported shaft 38d is supported by the inner surface of the bearing 70 in surface contact.

Further, in the configuration shown in FIG. 14, the cylindrical bush 71a is fitted as an oil retaining bush without oil-supply bearing between inner surfaces of the input shaft 38a of the joint member 38 and the boss section 32g of the boss-attached presser 32a facing the hollow section 32j.

Further, the cylindrical bush 71a restricts movements towards the fitting shaft 38c by using a stopper section 32m formed on the boss-attached presser 32a and protruding towards the hollow section 32j. In detail, a protruding end surface of the stopper section 32m is formed overlapping with a thickness portion of the cylindrical bush 71a.

According to such configuration, the joint member 38 can be rotatably supported in a cheaper way than using the bearing 70 so the lateral vibration can be prevented since the input shaft 38a is supported by the inner surface the cylindrical bush 71a in surface contact.

Further, in the configuration shown in FIG. 15, the flange bush 71b is fitted between inner surfaces of the supported shaft 38d and the bush 32d. The flange bush 71b is installed on the joint member 38 by making a flange 71c formed on the end to be located beside the flange 38b of the joint member 38.

According to such configuration, a supported shaft 38d can be rotatably supported by using the flange bush 71b so the lateral vibration can be prevented since the supported shaft 38d is supported by the inner surface of the flange bush 71b in surface contact.

Moreover, the flange 71c is disposed on a position to be pressed against the bush 32d so as to restrict movements of the flange bush 71b in an axial direction by using the bush 32d. Thus, the joint member 38 is stably supported by the flange bush 71b.

### MODIFICATION EXAMPLES OF THE DUST-PROOF STRUCTURE

As described above, with regard to the boss section 32g of the boss-attached presser 32a secured on the input section body 32, the joint member 38 connected to the boss section 32g relatively rotates together with the inner cable 40a of the rotary cable 40. Further, it is concerned that dust entered between the joint member 38 and the boss section 32g will interrupt rotation of the joint member 38. Under such circumstance, the timing for feeding the fuel to the injector 20 may not be the ideal timing since it is difficult for the eccentric cam 41a fitted to the joint member 38 to rotate smoothly.

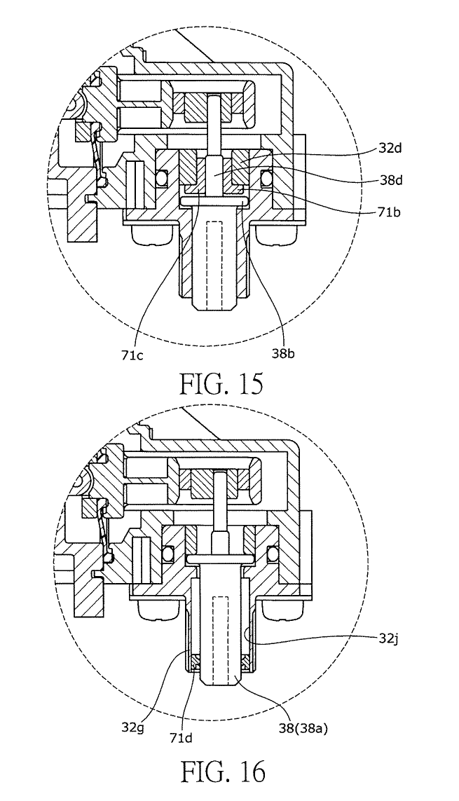

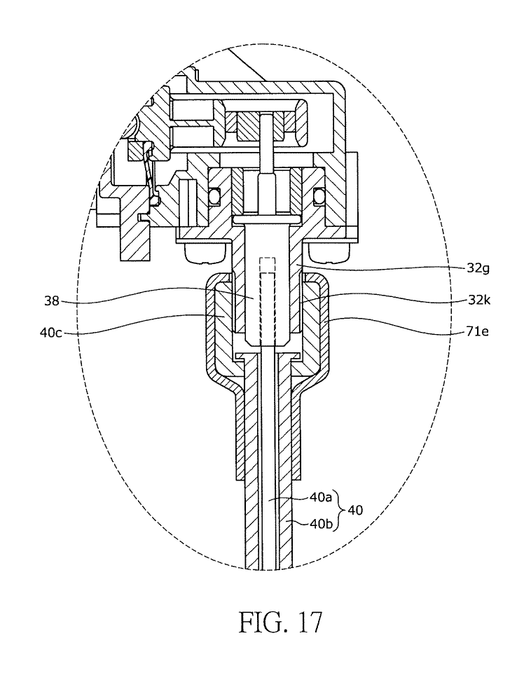

To prevent such adverse condition, the modification examples regarding the bearing structure for preventing dust intrusion between the joint member 38 and the boss section 32g are described below with reference to FIG. 16 and FIG. 17.

FIG. 16 is a partial enlarged cross-sectional view illustrating a configuration of the pump 30 provided with a seal 71d installed between the joint member 38 and the boss section 32g. FIG. 17 is a partial enlarged cross-sectional view illustrating a configuration of the pump 30 provided with a dust-proof cover 71e installed on the flare nut 40c and the outer cable 40b.

In the configuration shown in FIG. 16, the dust-proof seal 71d is disposed between inner surfaces of the input shaft 38a of the joint member 38 and the boss section 32g facing the hollow section 32j on a position starting from the end of the input shaft 38a to the end surface of the boss section 32g.

According to such configuration, dust can be prevented from intruding to the hollow section 32j from the end surface of the boss section 32g and smoothness of relative rotation of the joint member 38 to the boss section 32g can be ensured.

Further, in the configuration shown in FIG. 17, the dust-proof cover 71e is installed by covering the flare nut 40c (as the connection member for connecting the rotary cable 40 to the joint member 38) and the outer cable 40b of the rotary cable 40. The flare nut 40c covering the joint member 38 is screwed into the thread section 32k of the boss section 32g. That is to say, the flare nut 40c is screwed into the boss section 32g while the dust-proof cover 71e covers the flare nut 40c and the outer cable 40b so the space covered by the above is a sealed space.

According to such configuration, dust intrusion between the boss section 32g and the joint member 38 can be prevented, and smoothness of relative rotation of the joint member 38 to the boss section 32g can be ensured. Moreover, dust intrusion between the inner cable 40a and the outer cable 40b of the rotary cable 40 can be prevented to thereby ensuring smoothness of relative rotation of the inner cable 40a to the outer cable 40b.

The foregoing embodiments are merely examples for better understanding of the present invention rather than limitations to the invention. Modifications and improvements can be made to the present invention without departing from the scope or spirit of the invention, and their equivalents are naturally included in the present invention.

For example, the fuel injection device according to the embodiments may also adopt the crank shaft of the engine as the driving source in agricultural machines equipped with the recoil starter. In this way, as compared to the pump driven by the motors, speed for pressurizing the fuel can be accelerated during recoiling to reduce a recoiling count before starting.

Furthermore, the total power required by the FI system can be reduced by setting the pump to be mechanically driven to thereby realize miniaturization and low costs for the power generating device so the FI system without batteries can be realized in low costs.

Also, as described above, the configuration for transmitting the rotational torque to the pump by using the rotary cable with flexibility is preferable in terms of costs and ease of connection to the pump. In particular, the pump can be disposed near the tank at places away from the combustion chamber of the engine with low environmental temperature, such as a passage of forcedly air-cooled wind from a blower fan or at places away from oil coolers. Furthermore, return piping is no longer required if the ump is disposed inside the tank.

Also, the mechanism for transmitting power of the crank shaft and the like is not limited only to be the rotary cable. For example, a member combined by connecting rods and gears may also be used instead so the rotational torque is mechanically transmitted through engagements of the gears.

Moreover, in addition to cars and motorcycles, the fuel injection device of the invention can also be applied in tools provided with internal combustion engines, such as agricultural machines, boats and the like.

1. A pump for feeding a fuel from a tank to an injector injecting the fuel into an inlet pipe or a combustion chamber of an engine, the pump comprising:
a pump body having a pump chamber defined therein;
an input section applied with a rotational torque of a rotating member rotating in response to operation of the engine; and
a reciprocating member pressurizing and feeding the fuel sucked in the pump chamber to the injector,
the input section comprising a cam coupled to a transmitting member connected to the rotating member and transmitting the rotational torque for enabling the reciprocating member to reciprocate, a bearing section rotatably supporting the transmitting member, and a presser section restricting movements of the transmitting member in an axial direction.

2. The pump according to claim 1, wherein
the bearing section rotatably supports one end of the transmitting member in the axial direction, and
a length of the bearing section in the axial direction of the transmitting member is twice or more than twice an inner diameter of the bearing section.

3. The pump according to claim 1, wherein
the bearing section rotatably supports the transmitting member through a bush.

4. The pump according to claim 1, wherein
a seal is installed between the bearing section and the transmitting member.

5. The pump according to claim 1, wherein
the transmitting member comprises a rotary cable having a rotating inner cable and a non-rotating outer cable, a joint member coupling the inner cable with the cam as having an outer periphery be supported by the bearing section, and a connection member connecting the outer cable with an outer periphery of the bearing section, and
the pump comprises a cover covering the outer cable and the connection member.

6. The pump according to claim 1, wherein
the rotating member is a crank shaft, a balancer shaft, a cam shaft or a governor, and
the input section is connected to the transmitting member, and the transmitting member transmits the rotational torque to the cam from the crank shaft, the balancer shaft, the cam shaft or the governor.

7. The pump according to claim 6, wherein
the input section is connected to the transmitting member, and the transmitting member transmits the rotational torque to the cam from the crank shaft installed with a recoil starter, or the balancer shaft, the cam shaft or the governor operated together with the crank shaft.

8. The pump according to claim 1, wherein
the input section is connected to the transmitting member containing a bevel gear or a worm gear.

9. A fuel injection device, comprising
the pump according to claim 1;
the injector connected to the pump; and
the transmitting member connected to the rotating member and the input section.
